(19) United States
(12) Patent Application Publication
(10) Pub. No.: US 2012/0268310 A1
(43) Pub. Date: Oct. 25, 2012

(54) APPARATUS AND METHOD FOR INTELLIGENTLY CONTROLLING MOVING OBJECT

(75) Inventor: Ki Seok KIM, Daegu (KR)

(73) Assignee: Electronics and Telecommunications Research Institute, Daejeon (KR)

(21) Appl. No.: 13/451,388

(22) Filed: Apr. 19, 2012

(30) Foreign Application Priority Data
Apr. 21, 2011 (KR) 10-2011-0037327

(51) Int. Cl. G01S 13/93

(52) U.S. Cl. 342/70

(57) ABSTRACT

Provided is a smart radar apparatus for vehicle. The smart radar apparatus sets mobility or motion of a close vehicle as backup data by multiplexing a radar sensor and analyzing signals of multiple sensors. The backup data is indicated as two-dimensional (2D) data having magnitude data and direction vector of momentum. The smart radar apparatus accurately determines and predicts dangerousness by expressing the motion of the close vehicle as 2D vector data and by comparing mobility vector data of the close vehicle based on a mobility vector of a reference vehicle.

### CROSS-REFERENCE TO RELATED APPLICATIONS

This application claims priority to and the benefit of Korean Patent Application No. 10-2011-0037327 filed in the Korean intellectual Property Office on Apr. 21, 2011, the entire contents of which are incorporated herein by reference.

### TECHNICAL FIELD

The present invention relates to an apparatus and method for intelligently controlling a moving object, and more particularly, to an apparatus and method for intelligently controlling a moving object using a radar function.

### BACKGROUND ART

A radar apparatus mounted to a vehicle is configured as a unit sensor. Through the above configuration, the radar apparatus of the vehicle determines dangerousness according to a distance from a close vehicle. When determining the dangerousness, the radar apparatus of the vehicle initially determines the presence absence of the close vehicle or the distance from the close vehicle. The distance from the close vehicle is repeatedly measured at predetermined time intervals. The dangerousness is finally determined based on distance data obtained from the initial measurement and distance change data obtained through the repetitive measurement.

However, the distance data or the distance change data is all one-dimensional (1D) data and thus, determining of the dangerousness is inaccurate. Accordingly, the use of distance data or distance change data is degraded.

### SUMMARY OF THE INVENTION

The present invention has been made in an effort to provide an apparatus and method for intelligently controlling a moving object that intelligently controls a reference vehicle by two-dimensionally determining a motion of a close vehicle through a sensor-multiplexed radar apparatus.

An exemplary embodiment of the present invention provides an intelligent moving object control apparatus that is a smart radar apparatus for vehicle. The intelligent moving object control apparatus includes a radar apparatus, a speedometer apparatus, a control apparatus, and a danger avoidance apparatus. The radar apparatus configures at least two radars for measuring a distance from a close vehicle to provide the distance from the close vehicle and data required for position setting. The speedometer apparatus provides speed information of a reference vehicle. The control apparatus sets two-dimensional (2D) position data of the close vehicle using a signal of the radar apparatus and pre-set position information of a sensor, calculates vector data having momentum and directivity according to mobility of the close vehicle based on the reference vehicle using the measured data at predetermined time intervals, sets a danger index using backup data of the close vehicle, and controls the danger avoidance apparatus for danger avoidance when dangerousness is escalated. The danger avoidance apparatus includes a man machine interface (MMI) apparatus, a brake apparatus, and a steering apparatus. The MMI apparatus is to provide a driver with a warning in response to a request of the control apparatus when a danger level is determined to be at least a predetermined level. Similarly, the brake apparatus and the steering apparatus are to avoid danger in response to a request of the control apparatus.

The control apparatus may set a danger index using the distance from the close vehicle, a speed of the reference vehicle, a relative speed of the close vehicle, X axial data and Y axial data of backup data according to mobility of the close vehicle, and the like.

When the danger level is determined to be in a highly dangerous state, the control apparatus controls at least one of the brake apparatus and the steering apparatus to be driven using the set danger index in driving the danger avoidance apparatus.

According to exemplary embodiments of the present invention, the following effects may be obtained by two-dimensionally determining a motion of a close vehicle and intelligently controlling a reference vehicle through a sensor multiplexed radar apparatus. First, it is possible to accurately determine dangerousness since it is possible to determine a collision probability with the close vehicle based on various obtained information such as a speed of the reference vehicle, a relative speed of the close vehicle, a distance between the reference vehicle and the close vehicle, a motion of the close vehicle, and the like. Second, it is possible to predict future dangerousness of the close vehicle as well as current dangerousness of the close vehicle by two-dimensionally analyzing the motion of the close vehicle.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram schematically illustrating an apparatus for intelligently controlling a moving object according to an exemplary embodiment of the present invention.

FIGS. 2A, 2B, and 2C are block diagrams specifically illustrating an internal configuration of the intelligent moving object control apparatus according to the present exemplary embodiment.

FIG. 3 is an exemplary diagram in a case where the intelligent moving object control apparatus according to the present exemplary embodiment is mounted to a vehicle.

FIG. 4 is a graph illustrating a relationship between a transmission time and a reception time of a propagation signal of a radar apparatus configured as a unit sensor.

FIG. 5 is an exemplary diagram in a case where a radar apparatus including dual sensors is mounted to a vehicle.

FIG. 6 is a graph illustrating a relationship between a transmission time and a reception time of a propagation signal of a radar apparatus configured as dual sensors.

FIG. 7 is a block diagram illustrating an internal configuration in a case where the intelligent moving object control apparatus according to the present exemplary embodiment is mounted to a vehicle.

FIG. 8 is a diagram illustrating a process of two-dimensionally analyzing, by a reference vehicle mounted with the present intelligent moving object control apparatus, a motion of a close vehicle.

FIG. 9 is a flowchart illustrating a method of intelligently controlling a moving object according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. When assigning reference numerals to constituent elements of each drawing, like reference numerals refer to like elements throughout the specification, even though they are illustrated in different drawings. Also, when it is determined the detailed description related to a related known function or configuration may make the purpose of the present invention unnecessarily ambiguous in describing the present invention, the detailed description will be omitted here. Also, even though the exemplary embodiments of the present invention will be described in the following, technical spirit of the present invention is not limited thereto or restricted thereby and may be variously modified and thereby implemented by those skilled in the art.

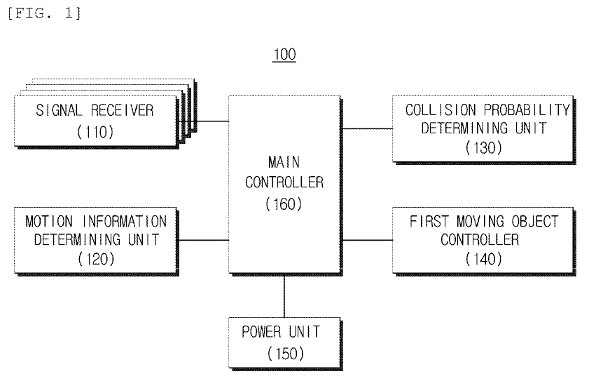

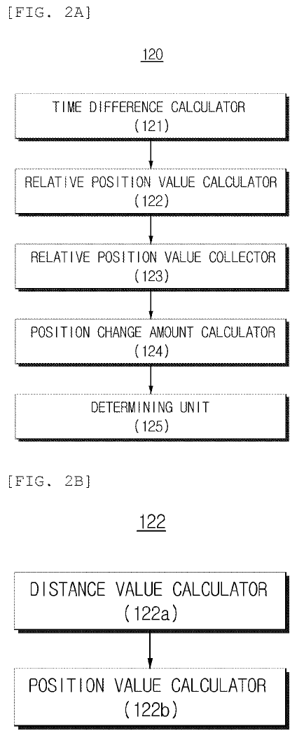

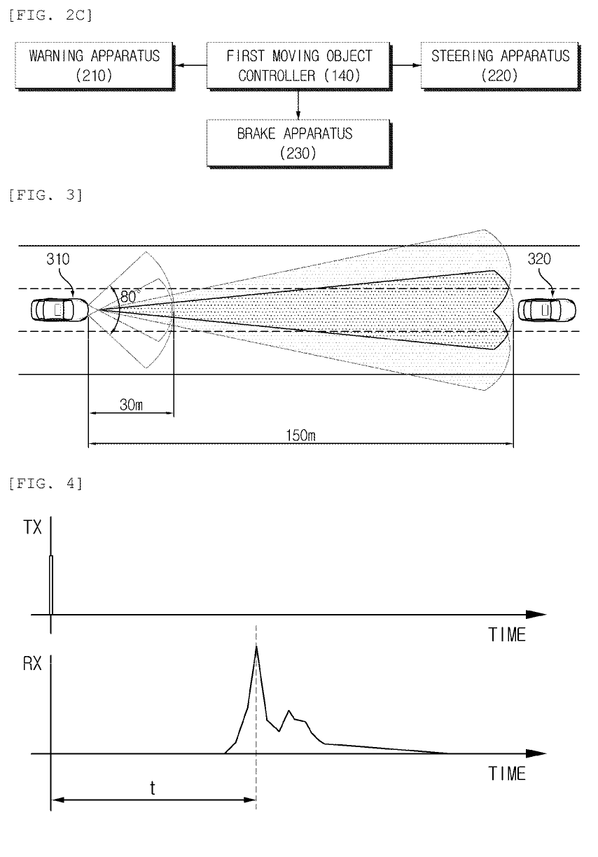

FIG. 1 is a block diagram schematically illustrating an apparatus for intelligently controlling a moving object according to an exemplary embodiment of the present invention. FIGS. 2A, 2B, and 2C are block diagrams specifically illustrating an internal configuration of the intelligent moving object control apparatus according to the present exemplary embodiment. Hereinafter, a description will be made with reference to FIGS. 1 and 2.

Referring to FIG. 1, an intelligent moving object control apparatus 100 includes a signal receiver 110, a motion information determining unit 120, a collision probability determining unit 130, a first moving object controller 140, a power unit 150, and a main controller 160.

The intelligent moving object control apparatus 100 is a smart radar apparatus for vehicle. The intelligent moving object control apparatus 100 sets mobility or motion of a close vehicle as vector data by multiplexing a radar sensor and analyzing signals of multiple sensors. The vector data indicates two-dimensional (2D) data having x axial data and y axial data, or magnitude data (r) and direction data (θ) of momentum. The intelligent moving object control apparatus 100 accurately determines and predicts dangerousness by expressing a motion of the close vehicle as 2D vector data and by comparing mobility vector data of the close vehicle based on a mobility vector of the reference vehicle, and provides dangerousness information to a user.

The signal receiver 110 functions to receive reflected signals that are reflected from a second moving object to multiple sensors mounted to a first moving object. In the present exemplary embodiment, the first moving object is a vehicle being driven and indicates a vehicle in which the user rides. The second moving object is a vehicle being driven and indicates a vehicle that is positioned at a close distance from the vehicle in which the user rides.

The signal receiver 110 may use, as the multiple sensors, a first sensor and a second sensor that are mounted to the first moving object at an interval corresponding to a difference in a reception time with respect to the same signal.

The signal receiver 110 may use, as the multiple sensors, the same distance measurement sensors. Here, a radar sensor for measuring an inter-vehicle distance may be applied as the distance measurement sensor. Meanwhile, the signal receiver 110 may use, as the multiple sensors, at least one distance measurement sensor and at least one motion recognition sensor. Here, the motion recognition sensor indicates a sensor that recognizes a motion or a position of a moving object (for example, a close vehicle).

The motion information determining unit 120 functions to determine motion information of the second moving object that is at least 2D information by interpreting the reflected signals based on a reception time.

As shown in FIG. 2A, the motion information determining unit 120 may include a time difference calculator 121, a relative position value calculator 122, a relative position value collector 123, a position change amount calculator 124, and a determining unit 125. Here, a case where the motion information determining unit 120 uses sensors for the same use as the multiple sensors is considered.

The time difference calculator 121 functions to calculate a reception time difference between received signals. In the present exemplary embodiment, the signal receiver 110 includes at least two radar sensors. The time difference calculator 121 initially calculates a time difference between a transmission signal and a received signal using each radar sensor and then obtains a distance vector. Next, the time difference calculator 121 calculates a time difference between received signals using radar sensors included in the signal receiver 110.

The relative position value calculator 122 functions to calculate a relative position value of the second moving object based on the first moving object, based on the reception time difference. As shown in FIG. 2B, the relative position value calculator 122 may include a distance value calculator 122a and a position value calculator 122b. The distance value calculator 122a functions to calculate a distance value between the first moving object and the second moving object using the reception time difference. The position value calculator 122b functions to calculate a relative position value of the second moving object using a position value of the first moving object and the distance value.

The relative position value collector 123 functions to collect the calculated relative position values with respect to the second moving object during a predetermined period of time at predetermined time intervals.

The position change amount calculator 124 functions to calculate a position change amount of the second moving object based on the collected relative position values.

The determining unit 125 functions to determine motion information of the second moving object based on the calculated position change amount. As the motion information, the determining unit 125 determines a speed value of the second moving object and a moving direction value of the second moving object or determines a speed value of the second moving object into one direction and a speed value of the second moving object into another direction. When the determining unit 125 determines the speed value and the moving direction value of the second moving object as the motion information, the motion information may be expressed as 2D data having magnitude data and direction data of momentum. Also, when the determining unit 125 determines the speed value of the second moving object into one direction and the speed value of the second moving object into the other direction as the motion information, the motion information may be expressed as 2D data having x axial data and y axial data. The speed is a displacement of a position vector that has moved during a unit period of time and thus, may be defined as a vector amount indicating a speed of an object. The speed includes information about how fast the object is and information about a moving direction and thus, it is possible to express the motion information as the x axial data and the y axial data.

The collision probability determining unit 130 functions to determine a collision probability between the first moving object and the second moving object based on the motion information of the second moving object. In the present exemplary embodiment, the motion information determining unit 120 may determine motion information of the second object at predetermined time intervals. Considering the above aspect, the collision probability determining unit 130 may determine the collision probability using a corresponding position value of the first moving object and the determined motion information of the second moving object at the predetermined time intervals. When determining the collision probability, the collision probability determining unit 130 may further use a speed of the first moving object and a relative speed of the second moving object.

The first moving object controller 140 functions to control the first moving object based on the determination result of the collision probability determining unit 130. As shown in FIG. 2C, the first moving object controller 140 may control at least one of a warning apparatus 210, a steering apparatus 220, and a brake apparatus 230, mounted to the first moving object to be driven based on a predetermined control condition. The control condition may be determined by integrally considering the position value of the first moving object, motion information of the second moving object, the speed of the first moving object, the relative speed of the second moving object, and the like. For example, when it is interpreted from the motion information of the second moving object that the second moving object positioned in front of the first moving object is to enter a lane of the first moving object and when the speed of the second moving object is slower than the speed of the first moving object, the first moving object controller 140 may determine that the collision probability is high and may control the brake apparatus 230 to be driven. On other hand, when it is interpreted that the second moving object is to enter the lane of the first moving object, but when the speed of the second moving object is faster than the speed of the first moving object, the first moving object controller 140 may determine that the collision probability is at a medium level, and may control the warning apparatus 220 to be driven. Meanwhile, when it is determined that the second moving object is not to enter the lane of the first moving object, the first moving object controller 140 may determine that the collision probability is low and may not perform any function.

The power unit 150 functions to supply power to each module constituting the intelligent moving object control apparatus 100.

The main controller 160 functions to control the overall operation of each module constituting the intelligent moving object control apparatus 100.

The present invention proposes a radar apparatus for detecting danger possibly close to a vehicle as an intelligent moving object control apparatus. In general, the radar apparatus detects only a distance from a close vehicle using a unit sensor and determines dangerousness according to the distance and thereby informs a driver of the dangerousness. However, when setting a danger index with a function using only the distance from the close vehicle, many errors may occur. The present invention proposes a highly reliable radar apparatus that may set backup data having momentum and directivity of the close vehicle using a multi-radar apparatus and thereby determine dangerousness and predict future dangerousness.

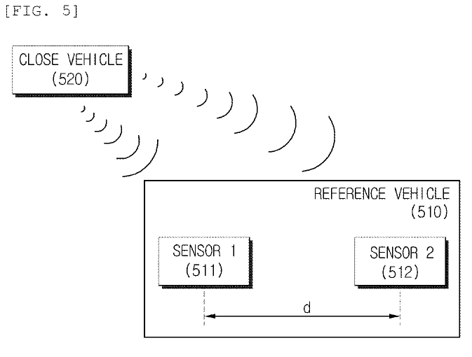

FIG. 3 is an exemplary diagram in a case where the intelligent moving object control apparatus 100 according to the present exemplary embodiment is mounted to a vehicle. In FIG. 3, a reference numeral 310 indicates a reference vehicle and a reference numeral 320 indicates a close vehicle. The reference vehicle 310 is mounted with the intelligent moving object control apparatus 100 and indicates a vehicle equipped with a front radar apparatus that is a representative function of an intelligent vehicle. Here, the reference vehicle 310 monitors the front using a radar and detects a dangerous situation. When the dangerous situation is detected within a predetermined distance, the reference vehicle 310 generates a warning for a driver and automatically operates a brake in an urgent situation.

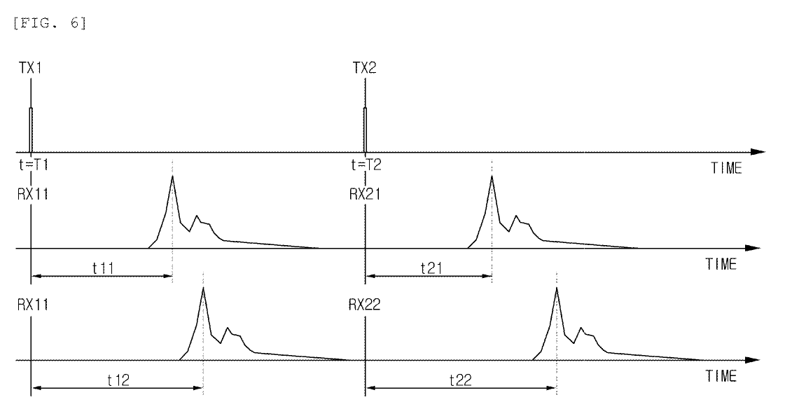

FIG. 4 is a graph illustrating a relationship between a transmission time and a reception time of a propagation signal of a radar apparatus configured as a unit sensor. As shown in FIG. 4, when the radar apparatus is configured as the unit sensor, the radar apparatus detects the presence/absence of a close vehicle and a distance from the close vehicle using a reception time difference (t) between a transmission time of a radio wave and a reception time of a radio signal that is transmitted and reflected and thereby is received.

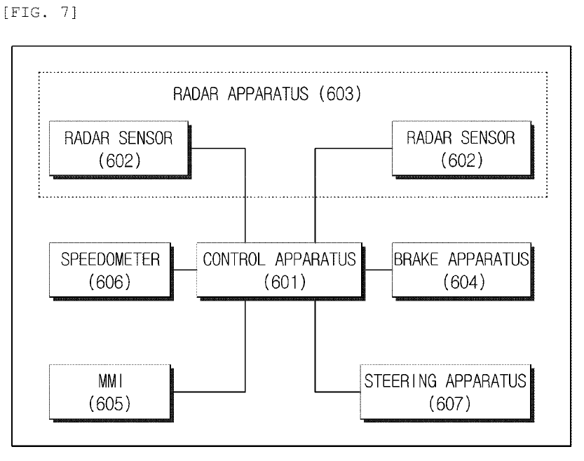

FIG. 5 is an exemplary diagram in a case where a radar apparatus including dual sensors is mounted to a vehicle. In the present exemplary embodiment, the intelligent moving object control apparatus 100 may be configured as a radar apparatus including dual sensors, that is, a sensor (1) 511 and a sensor (2) 512. A multi-radar apparatus sets 2D position data of a close vehicle 520 based on a reference vehicle 510 using a reception time difference between the dual sensors, that is, the sensor (1) 511 and the sensor (2) 512. By collecting position data at predetermined time intervals, the multi-radar apparatus sets vector data having momentum (speed) that indicates a change amount of 2D position data, and directivity. The vector data with respect to mobility of the close vehicle 520 may also be expressed by momentum of an x axis and momentum of a y axis. By applying mobility vector data of the close vehicle 520 based on vector data including a speed of the reference vehicle 510, based on a current position of the reference vehicle 510, it is possible to accurately determine dangerousness and to predict future dangerousness.

FIG. 6 shows a signal transmission and reception form of a radar apparatus using the dual sensors of FIG. 5. Initially, the reference vehicle 510 transmits a transmission signal TX1 at a predetermined time (t=T1). After a predetermined period of time, the transmission signal TX1 is reflected from the close vehicle 520 whereby signals RX11 and RX12 are received by the sensor (1) 511 and the sensor (2) 512, respectively. A distance from the close vehicle 512 is verified using a delay time of the received signals R1 and RX2. Position data 1 of the close vehicle 512 is set by combining signals of two sensors, that is, the sensor (1) 511 and the sensor (2) 512. After a predetermined period of time, the above process is repeated and position data 2 of the close vehicle 512 is set. Using the position data 1 and the position data 2, vector data (momentum, directivity) with respect to the mobility of the close vehicle 512 is set based on the reference vehicle 511. Using data such as a speed of the reference vehicle 511, a relative speed of the close vehicle 512, a distance from the close vehicle 512, directivity of the close vehicle 512, and the like, it is possible to determine dangerousness.

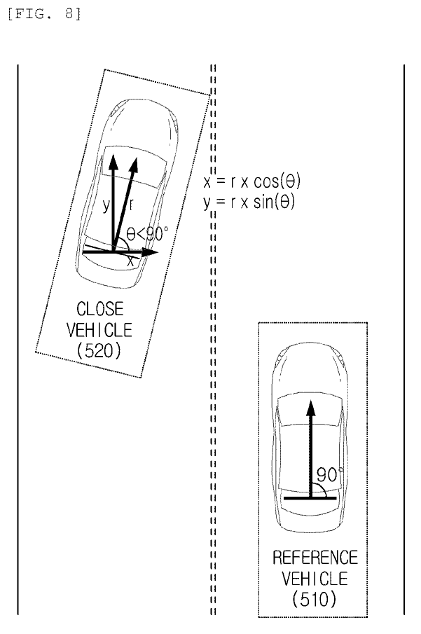

FIG. 7 is a block diagram illustrating an internal configuration in a case where an intelligent moving object control apparatus according to the present exemplary embodiment is mounted to a vehicle. A radar apparatus 602 is to determine the presence/absence of a predetermined close vehicle or to measure a distance from the predetermined close vehicle. A radar apparatus 603 includes at least two radar sensors 602 to provide data for measuring the distance from the predetermined close vehicle, a position thereof, and the like. The control apparatus 601 sets the distance from the close vehicle and position data thereof using preset position information of the radar sensor 602 and at least two signals received by the radar apparatus 603, and calculates vector data having momentum and directivity with respect to mobility of the close vehicle by re-measuring position data of the close vehicle at predetermined time intervals. As necessary, the control apparatus 601 determines dangerousness using current speed data provided from a speedometer 606, a calculable relative speed, and the like. When reaching a predetermined dangerous level, the control apparatus 601 may provide a warning to the user using a man machine interface (MMI) apparatus 605, or may enable the user to cope with a dangerous situation using a brake apparatus 604, a steering apparatus 607, and the like. The MMI apparatus 605 provides a warning signal and the like to the user according to a control of the control apparatus 601. The brake apparatus 604 may decrease a speed of the vehicle in response to an operation of the user, or may decrease the speed of the vehicle in response to a request of the control apparatus 601. The steering apparatus 607 may control directivity of the vehicle in response to a request of the user, or may control the directivity of the vehicle in response to the request of the control apparatus 601.

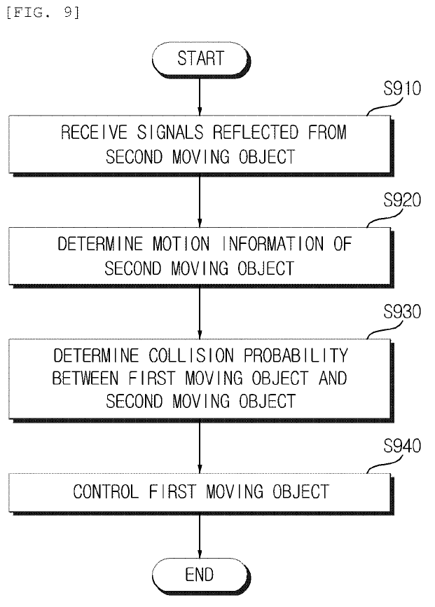

FIG. 8 is a diagram illustrating a process of two-dimensionally analyzing, by a vehicle mounted with the present intelligent moving object control apparatus, a motion of a close vehicle. FIG. 8 schematically expresses kinetic energy between a reference vehicle 510 and a close vehicle 520. The kinetic energy expressed as vector data has magnitude (speed) (r) and directivity (θ). The vector data may indicate the magnitude and the directivity as an x axial kinetic energy component (x=r×cosθ) and a y axial kinetic motion component (y=r×sinθ). In the present exemplary embodiment, the intelligent moving object control apparatus may set a danger index based on various parameters as follows.

Danger index=function {distance, speed and relative speed, x axial component of mobility vector data of close vehicle, y axial component of mobility vector data of close vehicle}

FIG. 9 is a flowchart illustrating a method of intelligently controlling a moving object according to an exemplary embodiment of the present invention.

Initially, reflected signals that are reflected from a second moving object to multiple sensors mounted to a first moving object are received (signal receiving step S910). In signal receiving step S910, it is possible to use, as the multiple sensors, a first sensor and a second sensor mounted to the first moving object, at an interval corresponding to a difference in a reception time with respect to the same signal. In signal receiving step S910, it is possible to use, as the multiple sensors, the same distance measurement sensors. It is also possible to use at least one distance measurement sensor and at least one motion recognition sensor.

After signal receiving step S910, motion information of the second moving object that is at least 2D information is determined by interpreting the reflected signals based on a reception time (motion information determining step S920).

Motion information determining step S920 may include a time difference calculating step, a relative position value calculating step, a relative position value collecting step, a position change amount calculating step, and a determining step.

In the time difference calculating step, a reception time difference between received signals is calculated. In the relative position value calculating step, a relative position value of the second moving object based on the first moving object is calculated based on the reception time difference. In the relative position value collecting step, the calculated relative position values with respect to the second moving object are collected during a predetermined period of time. In the position change amount calculating step, a position change amount of the second moving object is calculated based on the collected relative position values. In the determining step, motion information of the second moving object is determined based on the calculated position change amount.

The relative position value calculating step may include a distance calculating step and a position value calculating step. In the distance value calculating step, a distance value between the first moving object and the second moving object is calculated using the reception time difference. In the position value calculating step, a relative position value of the second moving object using the position value of the first moving object and the distance value.

Meanwhile, in the determining step, it is possible to determine, as the motion information, a speed value of the second moving object and a moving direction value of the second moving object or to determine a speed value of the second moving object into one direction and a speed value of the second moving object into another direction.

After motion information determining step S920, a collision probability between the first moving object and the second moving object is determined based on the motion information of the second moving object (collision probability determining step S930).

In motion information determining step S920, the motion information of the second moving object may be determined at predetermined time intervals. Considering the above aspect, in collision probability determining step S930, it is possible to determine the collision probability using a corresponding position value of the first moving object and the determined motion information of the second moving object at the predetermined time intervals. Meanwhile, in collision probability determining step S930, when determining the collision probability, it is possible to further use a speed of the first moving object and a relative speed of the second moving object.

After collision probability determining step S930, the first moving object is controlled based on the determination result of the collision probability (first moving object controlling step S940). In first moving object controlling step S940, it is possible to control at least one of a collision avoidance apparatus such as a warning apparatus, a steering apparatus, a brake apparatus, and the like, mounted to the first moving object, and a damage reduction apparatus such as an airbag and the like, to be driven based on a predetermined control condition.

An intelligent moving object control apparatus according to the present invention may be configured as a smart radar apparatus of a vehicle and may be applied to an embedded system for intelligent vehicle.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for intelligently controlling a moving object, the apparatus comprising:
a signal receiver to receive reflected signals that are reflected from a second moving object to multiple sensors mounted to a first moving object;
a motion information determining unit to determine motion information of the second moving object that is at least two-dimensional (2D) information by interpreting the reflected signals based on a reception time;
a collision probability determining unit to determine a collision probability between the first moving object and the second moving object based on the motion information of the second moving object; and
a first moving object controller to control the first moving object based on the determination result of the collision probability.

2. The apparatus of claim 1, wherein the motion information determining unit comprises:
a time difference calculator to calculate a reception time difference between received signals;
a relative position value calculator to calculate a relative position value of the second moving object based on the first moving object, based on the reception time difference;
a relative position value collector to collect the calculated relative position values with respect to the second moving object at predetermined time intervals;
a position change amount calculator to calculate a position change amount of the second moving object based on the collected relative position values; and
a determining unit to determine motion information of the second moving object based on the calculated position change amount.

3. The apparatus of claim 2, wherein the relative position value calculator comprises:
a distance value calculator to calculate a distance value between the first moving object and the second moving object using the reception time difference; and
a position value calculator to calculate a relative position value of the second moving object using the distance value, based on the first moving object.

4. The apparatus of claim 2, wherein the determining unit determines, as the motion information, a speed value of the second moving object and a moving direction value of the second moving object or determines, as the motion information, a speed value of the second moving object into one direction and a speed value of the second moving object into another direction.

5. The apparatus of claim 1, wherein the signal receiver uses, as the multiple sensors, at least two sensors mounted to the first moving object at a distance corresponding to a difference in a reception time with respect to the same transmission signal.

6. The apparatus of claim 1, wherein the signal receiver uses, as the multiple sensors, the same distance measurement sensors.

7. The apparatus of claim 1, wherein the collision probability determining unit determines the collision probability using determined distance and motion information of the second moving object based on the first moving object at predetermined time intervals.

8. The apparatus of claim 7, wherein, when determining the collision probability, the collision probability determining unit further uses a speed of the first moving object and a relative speed of the second moving object.

9. The apparatus of claim 1, wherein the first moving object controller controls a collision avoidance apparatus including at least one of a warning apparatus, a steering apparatus, and a brake apparatus, mounted to the first moving object, or a damage reduction apparatus performing an airbag function to be driven based on a predetermined control condition.

10. The apparatus of claim 1, wherein the signal receiver uses, as the multiple sensors, at least two distance measurement sensors.

11. A method of intelligently controlling a moving object, the method comprising:
receiving reflected signals that are reflected from a second moving object to multiple sensors mounted to a first moving object;
determining motion information of the second moving object that is at least 2D information by interpreting the reflected signals based on a reception time;
determining a collision probability between the first moving object and the second moving object based on the motion information of the second moving object; and
controlling the first moving object based on the determination result of the collision probability.

12. The method of claim 11, wherein the determining of the motion information comprises:
calculating a reception time difference between received signals;
calculating a relative position value of the second moving object based on the first moving object, based on the reception time difference;
collecting the calculated relative position values with respect to the second moving object at predetermined time intervals;
calculating a position change amount of the second moving object based on the collected relative position values; and
determining motion information of the second moving object based on the calculated position change amount.

13. The method of claim 12, wherein the calculating of the relative position value comprises:
calculating a distance value between the first moving object and the second moving object using the reception time difference; and
calculating a relative position value of the second moving object using the distance value, based on the first moving object.

14. The method of claim 12, wherein the determining of the motion information determines, as the motion information, a speed value of the second moving object and a moving direction value of the second moving object or determines, as the motion information, a speed value of the second moving object into one direction and a speed value of the second moving object into another direction.

15. The method of claim 11, wherein the determining of the collision probability determines the collision probability using determined distance and motion information of the second moving object based on the first moving object at predetermined time intervals.

16. The method of claim 15, wherein the determining of the collision probability further uses a speed of the first moving object and a relative speed of the second moving object when determining the collision probability.

17. The method of claim 11, wherein the controlling of the first moving object controls a collision avoidance apparatus including at least one of a warning apparatus, a steering apparatus, and a brake apparatus, mounted to the first moving object, or a damage reduction apparatus performing an airbag function to be driven based on a predetermined control condition.
